(19) United States
(12) Patent Application Publication
(10) Pub. No.: US 2019/0055916 A1
(43) Pub. Date: Feb. 21, 2019

(54) CONTROL SYSTEM FOR MACHINE ELECTRIC GENERATOR

(71) Applicant: Ernest William Townsend, IV, Scottsdale, AZ (US)

(72) Inventor: Ernest William Townsend, IV, Scottsdale, AZ (US)

(21) Appl. No.: 15/829,039

(22) Filed: Dec. 1, 2017

Related U.S. Application Data
(63) Continuation-in-part of application No. 15/677,800, filed on Aug. 15, 2017.

(51) Int. Cl. F03B 17/04; F03G 7/10

(52) U.S. Cl. CPC F03B 17/04; F03G 7/10

(57) ABSTRACT

A system is provided for controlling a machine which relies on recycling a buoyant module through a duty cycle to generate electric power. Specifically, control is provided by monitoring velocities of the module during its duty cycle in the machine. For its operation, the machine requires a bi-level tank that includes a transfer tank having a lower level water surface and a return tank having an upper level water surface. A two-valve mechanism operates during each duty cycle to provide module access into the bi-level tank and to maintain the respective water levels. During a gravity phase of the duty cycle, the module is dropped from a launch point to establish a constant module velocity for its engagement with a generator prior to entering the bi-level tank. In a buoyancy phase, the module is returned through the bi-level tank to the launch point by its buoyancy.

This application is a continuation-in-part of application Ser. No. 15/677,800, filed Aug. 15, 2017, which is currently pending. The contents of application Ser. No. 15/677,800 are incorporated herein by reference.

### FIELD OF THE INVENTION

The present invention pertains generally to machines for running electric generators and to control units for controlling these machines during their operational duty cycles. More particularly, the present invention pertains to machines that run electric generators by converting the potential energy of an object into kinetic energy for use in running the electric generator, as the object falls under the influence of gravity. The present invention is particularly, but not exclusively, useful for machines that use a body of liquid (e.g. water) to dissipate the kinetic energy of an object, and then use the buoyant force that is exerted by the liquid against the object to return it to a launch point for subsequently generating kinetic energy for the object to do further work in another duty cycle. The present invention is also useful for controlling velocities of an object during its duty cycle.

### BACKGROUND OF THE INVENTION

From an engineering perspective, the present invention requires a general familiarity with the concepts of work and energy, and their interrelationship with each other. In particular, the present invention is concerned with the work-energy relationship of a moving object.

By definition, the work, U, that is done by a force, F, when moving an object from one location (position) to another, is equal to the product of the force, F, and the displacement, dr, of the object. Mathematically, work is expressed as:

U=Fdr

On the other hand, the kinetic energy, T₁ of an object in motion (i.e. its capacity to do work as a moving object) is mathematically expressed as:

T=½mv²

where m is the mass of the object and v is its velocity at a point in time.

In accordance with the general principle of work and energy, it can be shown that as an object moves under the influence of a force F through a displacement dr, the kinetic energy T of the object will be changed by the work U done on or by the object. Mathematically:

T₁+U_{1→2}=T₂

Stated differently, the kinetic energy at a first position, T₁, plus the work required to move the object from the first position to a second position, U_{1→2}, is equal to the kinetic energy of the object at the second position, T₂.

With the above relationships in mind, it is also helpful to know that the energy of a body can be expressed either as potential energy or kinetic energy. The distinction here is that an object has potential energy by virtue of its position or configuration (i.e. static), whereas it has kinetic energy by virtue of its motion (dynamic). The present invention incorporates considerations of both types of energy in two different contexts.

Along with a consideration of energy in the context of an object falling under the force of gravity, the present invention is also concerned with the energy of an object in a context wherein the object is submerged in a liquid (e.g. water). In this latter context, a buoyant force will act on the submerged object that is equal to the weight of the liquid that is displaced by the object. Though the contexts are different, the force of gravity and a buoyant force will have similar dynamic effects on an object, insofar as the work-energy relationship is concerned.

In overview, as envisioned for a duty cycle of the present invention, the force of gravity will convert the potential energy of an object into kinetic energy as the object falls from a predetermined height into a liquid tank. Part of the object's kinetic energy during its fall will then be used to do work in operating an electric generator for generating electricity. Subsequently, a buoyant force acting on the object in the liquid tank will give the object sufficient kinetic energy to return the object to the position of height from which it was originally dropped.

As an object (body) moves it will have a velocity. Mathematically, this velocity is properly considered as a vector which has both a magnitude (i.e. speed) and a direction. Speed and direction should therefore be considered separately. In this context, speed (i.e. the magnitude of the velocity vector) is equal to a change in the travel distance of the object per unit time (e.g. MPH).

For the present invention, the velocity of an object as it is being moved during a duty cycle will have dramatic changes in both its magnitude and direction. Consequently, measurements of time, travel distance and changes in directions, together with the factors causing these changes, are of crucial importance for the present invention. In sum, the velocity of an object needs to be monitored and controlled.

In light of the above, It is an object of the present invention to provide a machine that converts the kinetic energy of a falling object into work for the operation of an electric generator. Still another object of the present invention is to provide a machine that creates a buoyant force on an object that will generate sufficient kinetic energy for the object to return it to a predetermined height. Yet another object of the present invention is to provide a machine with a valve mechanism for a liquid tank that reconfigures the tank to alternately provide a low pressure head, h₁, and a high pressure head, h₂, in the same liquid tank. Still another object of the present invention is to establish control over the velocity of an object as it travels through the machine during a duty cycle. Another object of the present invention is to provide a machine for generating electrical energy that is easy to use, is relatively simple to install, and is competitively cost effective.

### SUMMARY OF THE INVENTION

In accordance with the present invention, a machine for operating an electric generator incorporates five groups of components. These groups are: i) a bi-level liquid (e.g. water) tank having both a lower level liquid surface, and a higher level liquid surface; ii) a valve mechanism, included with the bi-level tank, for maintaining the higher level liquid surface above the lower level liquid surface; iii) a module falling under the force of gravity for transferring energy from the module into work for operating the electric generator; iv) a displacement device in the bi-level tank for controlling variations in the liquid surface levels; and v) a control unit for using the valve mechanism to recycle the module through the bi-level liquid tank.

Within the combination of components for the present invention, a power path is established for the module. Specifically, the power path sequentially extends from a launch point above the tank and through a fall zone where kinetic energy is generated for the module. As envisioned for the present invention, this fall zone can be variable and can be either lengthened or shortened according to the needs of the user. In the event, after the module clears the fall zone, the module then engages with the electric generator for travel through an energy transfer section on the power path. It is in this energy transfer section where kinetic energy is transferred from the module for use as work by the electric generator in the generation of electricity.

After the module leaves the power path it enters the bi-level tank through the lower level liquid surface. In the bi-level tank, the module decelerates to zero vertical velocity at a deceleration point. At the deceleration point in the tank, a transfer mechanism, which is located inside the tank for receiving the module from the power path, repositions the module. Specifically, the module is repositioned onto a return path for buoyant acceleration of the module. On the return path, the module leaves the tank through the upper level liquid surface of the tank for a return to the launch point.

In detail, the bi-level tank includes a transfer tank that is formed with an entry port and an exit port. It also includes a return tank that is mounted on the transfer tank, and positioned above the exit port of the transfer tank. In this combination, fluid communication can be selectively established between the transfer tank and the return tank through the exit port. Preferably the entry port is above the exit port. In an alternate embodiment, however, the entry port and the exit port are horizontally coplanar.

For purposes of the present invention, the valve mechanism includes an access valve which is positioned at the entry port of the transfer tank for opening and closing the entry port. The valve mechanism also includes a transfer valve that is positioned adjacent the exit port of the transfer tank for effectively opening and closing the exit port between the transfer tank and the return tank. In this combination, it is particularly important that a respective operation of the access valve and the transfer valve be coordinated in accordance with a predetermined procedure to ensure the entry port is closed whenever the exit port is open.

The essential aspect of the predetermined protocol for an operation of the valve mechanism is that a condition wherein the entry port and the exit port are simultaneously open, must be avoided. This is required because the exit port is submerged below the higher level liquid surface. Consequently, if both the entry port and exit port are open simultaneously, liquid would flow from the return tank into the transfer tank and out of the entry port from the bi-level tank. In the context of the present invention, starting from a configuration wherein the access valve is open and the transfer valve is closed, the access valve (open/close) and transfer valve (close/open) will change on only two occasions during a duty cycle of the machine for the present invention. The first is after the module enters the bi-level tank, and the second is after the module exits from the bi-level tank.

While the module is in the bi-level tank, i.e. when the entry port is closed and the exit port is open, the module decelerates and is repositioned. This is done by the transfer mechanism which includes a receiver having a first end and a second end. The transfer mechanism also includes a pivot mechanism that is mounted inside the transfer tank. In detail, the pivot mechanism is attached to the second end of the receiver and defines a pivot point for rotation of the receiver. In a first orientation, the first end of the receiver is positioned in the transfer tank below the access port for receiving the module as it enters the transfer tank. In a second orientation, the first end of the receiver is repositioned below the exit port for releasing the module from the transfer tank and into the return tank.

Additionally, also located inside the transfer tank is a displacement device which is preferably an expandable bladder. It is an important aspect of the present invention that the displacement device, when activated, will displace a volume, V_{d}, of liquid in the transfer tank that is equal to the displacement volume V_{d} of the module. With this in mind, it is also important to appreciate that prior to the module entering the transfer tank (i.e. entry port is open), the lower level liquid surface is at a distance Δ₁ below the entry port, such that the transfer tank is a volume V_{d} short of being completely full. Thus, when the module enters the transfer tank, the entry port is closed.

Continue to consider the module being in the transfer tank and the entry port closed by the access valve. Also, the exit port is now open. As the module is repositioned in the transfer tank, the displacement device is activated. In this case, the higher level liquid surface is raised by a distance Δ₂ to compensate for liquid displaced in the transfer tank by the displacement device. Consequently, when the module exits from the return tank, Δ₂ becomes zero as the higher level liquid surface returns to its original level. After the module has travelled through the exit port, preferably immediately after the module's exit, the transfer valve closes the exit port. Then, after the transfer valve has closed the exit port, while the access valve has opened the entry port, the displacement device is deactivated and returns to its original volume prior to expansion. The consequence here is that Δ₁ is restored in the transfer tank and the bi-level tank is properly configured to receive another module.

In compliance with the above disclosure, a duty cycle for an operation of the machine of the present invention will include a sequence wherein: i) the access valve is open, the transfer valve is closed and the displacement device is deactivated as the module enters the transfer tank through the entry port; ii) the access valve is closed, the transfer valve is open and the displacement device is activated while the module is submerged in the transfer tank and is being transferred into the return tank; iii) as the module leaves the return tank for travel to the launch point, and the transfer valve is closed, the access valve is opened; and iv) the access valve remains open and the transfer valve remains closed as the displacement device is deactivated and the tank is reconfigured for the next duty cycle.

As envisioned for the present invention, the machine is capable of working at least two types of electric generators. One case is where the electric generator is an electromagnetic generator having a rotor and a stator. In this case, a gripper is attached to the module and a chain is connected with the rotor of the generator. The gripper on the module then engages with the chain to move the chain during the fall of the module along the power path. In turn, the chain rotates the rotor to generate electric power from the generator. In the other case, the electric generator is a linear electric generator, and at least one magnet is mounted on the module. For this configuration, a solenoid is positioned along the power path of the module to generate electric power as the module falls along the power path for an interaction between the moving magnet on the module and the solenoid.

Thus far, the disclosure for a machine in accordance with the present invention has focused on a single module. As a practical matter, however, the present invention envisions a multi-module machine with a simultaneous employment of an n number of modules. For disclosure purposes, a four-module machine is considered (i.e. n=4).

For a multi-module machine configuration, a duty cycle is defined here as the total time required for one module to complete a round-trip circuit through the machine. Within a duty cycle, the time duration Tₑ that each individual module is engaged with the power generator is of utmost importance.

As envisioned for the present invention, crucial measurements for the control unit come directly from the power generator. Specifically, power level measurements and sine wave measurements of the generator's power output are necessary to ensure compatibility of the machine's operation with the requirements of the power provider/power company/utility. Thus, the power generator's output is essentially the start point for an operation of the machine.

It is axiomatic that in order for the machine to provide a continuous and effective input to a power generator, Tₑ for all modules is the same and they need to be continuous (i.e. ΣTₑ=nTₑ). Thus, the velocity of a module during its engagement with the power generator should be controlled and held substantially constant. Also, for a continuous operation in a duty cycle, one module must effectively engage with the power generator simultaneously with the disengagement of the previous module from the power generator.

It can happen, however, that during a duty cycle the total time 4Tₑ (i.e. a four-module machine) may vary somewhat. Moreover, although the velocity of a particular module during its engagement with the power generator will need to remain constant, its velocity will vary substantially during the remaining portion of a duty cycle when it is not engaged with the power generator. With these factors in mind, the disclosure presented below for controlling a multi-module machine is provided primarily in consideration of module velocities.

Because hydrodynamic changes (e.g. changes in temperature, pressure, density and viscosity) on a submerged module in the bi-level tank will have a meaningful effect on its velocities during a duty cycle, these hydrodynamic changes must be specifically considered for their effects on module velocities. With this in mind, control over a machine of the present invention requires information regarding module velocities during all phases of a duty cycle. This includes hydrodynamic effects on a module when it is submerged, as well as the requirements of the entity (e.g. a power grid) for which the power is generated.

In overview, it is to be appreciated that for the power requirements of a machine, the velocity of a module during its engagement with the power generator, Tₑ, will need to have a substantially constant average velocity, Vₚ. In this case, Vₚ is equal to the travel distance, s, of a module while it is engaged with the power generator, divided by its time of engagement (i.e. Vₚ=s/Tₑ). Recall, Vₚ needs to be controllable and is preferably constant during the time interval Tₑ. For purposes of the present invention, the variations in Vₚ that may be required for proper control of the machine can be implemented by varying the load required of the machine for the power provider/power company/utility.

During the remainder of a duty cycle (i.e. a time duration of 3T) the module is subject to many changes in its velocity as it is returned through the machine for reengagement with the power generator. Specifically, during its return, a module will decelerate, be redirected, accelerated by buoyancy, and then ejected from the bi-level tank onto a launch pad. From there, the module will again be launched for reengagement with the power generator. The present invention recognizes that the sum total of the different velocities, ΣVᵣₜₙ, that is experienced by the module during its return for reengagement, is a function of Vₚ (i.e. ΣVᵣₜₙ is f:(Vₚ)). Accordingly, Vₚ is a primary concern for control purposes.

Structurally, a control unit for controlling an operation of the present invention will include a timer for coordinating module movements during a duty cycle. Additionally, the control unit will be connected to a sensor array that includes hydrodynamic sensors, position/velocity sensors, and a power generator output gauge. More specifically, the hydrodynamic sensors in the array will be of types that are well known in the pertinent art and are capable of measuring specific fluid characteristics of the liquid in the bi-level tank. In particular, measurements of interest will include those that affect module velocities, such as pressure, temperature and viscosity. The hydrodynamic sensors will be submerged in the liquid and they will be specifically positioned to take pressure measurements relative to both the high and low liquid surface levels in the bi-level tank. Preferably, at least one hydrodynamic sensor will take measurements in the transfer tank when the entry port is open and the exit port is closed, while another will take measurements in the transfer tank when the entry port is closed and the exit port is open. Still another hydrodynamic sensor will take measurements in the transfer tank to monitor variations in the lower liquid surface level, Lₗₒ of the transfer tank.

In addition to the hydrodynamic sensors mentioned above, a plethora of position/velocity sensors for the present invention will be positioned on the machine, both inside the bi-level tank and external to the bi-level tank. The purpose here is to continuously monitor the velocities of each module as they traverse through their respective duty cycle. Preferably, a position/velocity sensor will be positioned at the launch pad and used to establish the beginning of each module's duty cycle. Also, a plurality of position/velocity sensors will be positioned along the machine's power path for measuring the velocity of a module, Vₚ , during its engagement with the power generator. Another plurality of position/velocity sensors will be positioned inside the bi-level tank, in the transfer tank and in the return tank, to monitor module travel between its engagements with the power generator.

To control an operation of the machine, the control unit uses inputs from the sensor array disclosed above. In detail, the control unit uses these inputs to operate i) internal guides that direct a module through the machine during its duty cycle, ii) the valve mechanism that allows module access into the bi-level tank and maintains respective liquid surface levels for the transfer tank and the return tank, iii) the displacement device in the transfer tank, and iv) the launch pad that establishes the start of each duty cycle. In combination, operations of the sensor array and the machine are coordinated by the control unit for purposes of running the machine.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a machine in accordance with the present invention showing its interactive components positioned relative to the duty cycle path of a module during an operation of the machine;

FIG. 2A is a cross-section of the machine as would be seen along the line 2-2 in FIG. 1 with the electric generator rotated into the cross-section plane for clarity, wherein the module has been launched for free fall from a launch point;

FIG. 2B is the machine as seen in FIG. 2A wherein the module has been repositioned in a transfer tank of the machine;

FIG. 2C is the machine as seen in FIG. 2B wherein the module has been accelerated by buoyancy for a return to the launch point and a repeat of the duty cycle;

FIG. 3 is a chart correlating the temporal and configurational relationships of the module to other components of the machine (i.e. valve and displacement mechanisms) during a duty cycle;

FIG. 4 is a schematic presentation for a machine of the present invention showing sensor placements necessary for controlling a module during a complete duty cycle;

FIG. 5 is a block diagram of interactive components for controlling the machine during a duty cycle; and

FIG. 6 is a linear time graph showing the velocities of a module during its duty cycle in relation to other modules and to the operation of the valve mechanism and the displacement device.

### DESCRIPTION OF THE PREFERRED EMBODIMENTS

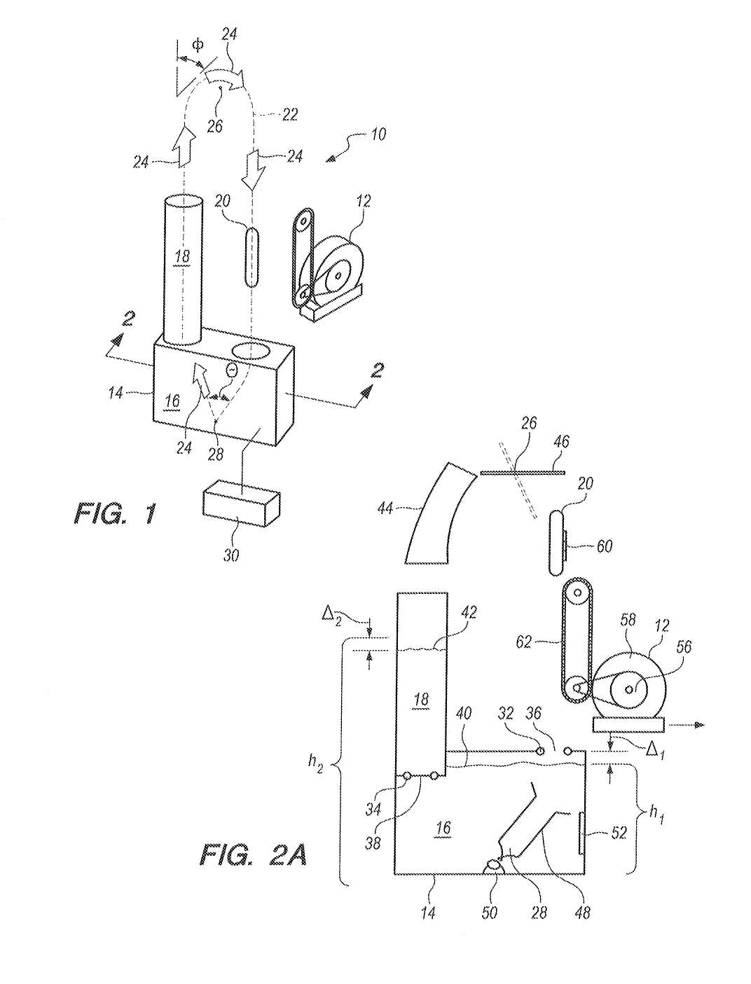

Referring initially to FIG. 1, a machine in accordance with the present invention is shown and is generally designated 10. As shown, the general purpose of the machine 10 is to provide motive forces for the operation of an electric generator 12. For this purpose, the machine 10 includes a bi-level tank 14 that includes a transfer tank 16 and a return tank 18. As intended for the present invention, a buoyant module 20 is moved by the machine 10 along a path 22 (indicated by arrows 24). In particular, the module 20 moves back and forth between a launch point 26, that is located above the bi-level tank 14, and a deceleration point 28 that is located inside the transfer tank 16. An operation of the machine 10 is directed by a control unit 30.

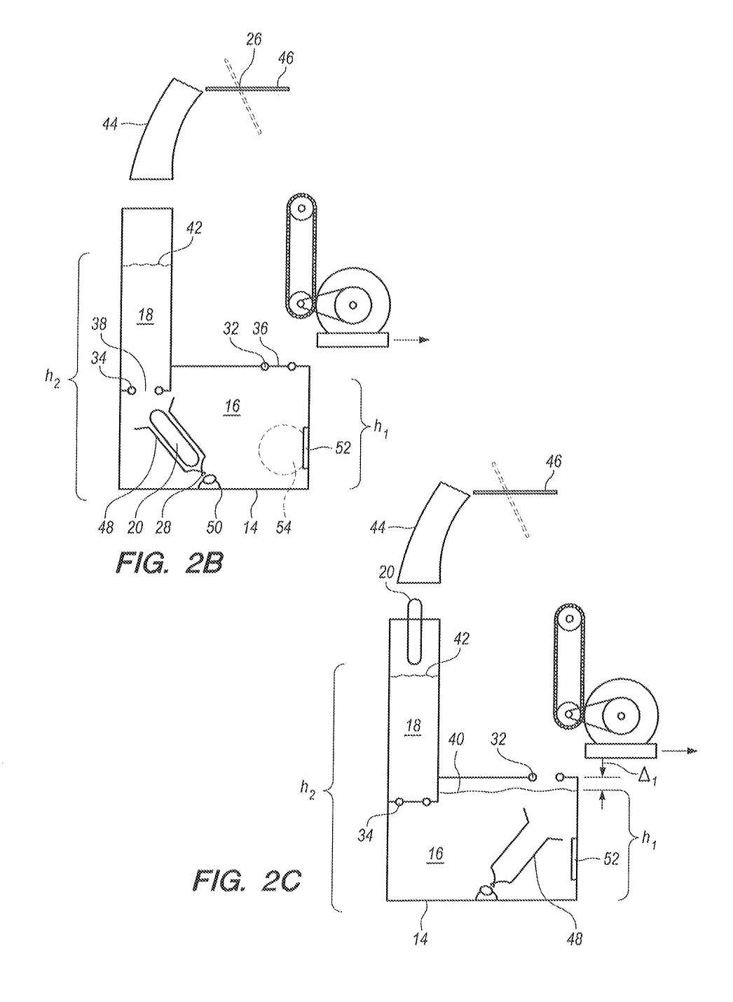

With reference to FIG. 2A, it will be seen that the bi-level tank 14 includes an access valve 32 and a transfer valve 34. Both the access valve 32 and the transfer valve 34 are connected with the control unit 30 that coordinates their cooperation and the timing for dropping a module 20 from the launch point 26. As shown, the access valve 32 is associated with an entry port 36, and it will operate to open and close the entry port 36. Similarly, the transfer valve 34 is associated with an exit port 38, and it will operate to open and close the exit port 38.

FIG. 2A also shows that the access valve 32 at the entry port 36 provides an opening into the transfer tank 16 from the external environs of the machine 10. On the other hand, the transfer valve 34 and the exit port 38 are located inside the bi-level tank 14, between the transfer tank 16 and the return tank 18. Thus, when the bi-level tank 14 is filled with a liquid (e.g. water) the transfer valve 34 and the exit port 38 will be submerged in the liquid. With this in mind, it is an important feature of the present invention that the condition is to be avoided wherein the access valve 32 and the transfer valve 34 are open at the same time. More specifically, when the access valve 32 (i.e. entry port 36) is open, the transfer valve 34 (i.e. exit port 38) must be closed.

In FIG. 2A, the machine 10 is shown in a configuration wherein the access valve 32 has opened the entry port 36, and the transfer valve 34 has closed the exit port 38. In this configuration, it is to be noted that liquid in the transfer tank 16 of the bi-level tank 14 is at a lower surface level 40 than is liquid in the return tank 18 at a higher surface level 42. Also, it is to be noted that there is a displacement Ai between the lower level liquid surface 40 and the entry port 36 and that the lower level liquid surface 40 is at a pressure head, h₁. Additional structural features of the machine 10 shown in FIG. 2A include a deflector/exit chute 44 which will eventually guide the module 20 through an angle ϕ (see FIG. 1) onto a launch pad 46 at the launch point 26, at the end of a duty cycle.

Proceeding now to FIG. 2B, another configuration for the machine 10 is shown wherein the entry port 36 has been closed and the exit port 38 opened. Specifically, this configuration is established only after the module 20 has completely entered the transfer tank 16. Also, in FIG. 2B it is shown that after entering the transfer tank 16, the module 20 is caught by a receiver 48 and it is rotated with the receiver 48 through an angle θ (see FIG. 1) by a pivot mechanism 50 to reposition the module 20 in the transfer tank 16. FIG. 2B also shows that a displacement device 52 is positioned in the transfer tank 16. Preferably, the displacement device 52 includes an expandable bladder 54.

By cross referencing FIG. 28 with FIG. 2A, it will be seen that once the module 20 is submerged in the transfer tank 16, the displacement distance Δ₁ effectively goes to zero. Also, FIG. 2B indicates that the displacement device 52 has been activated to expand the bladder 54. At this point, three different actions have taken place that are related to the displacement volume V_{d} of the module 20. For one, because the fluid volume in the transfer tank 16, which is above the lower surface level 40 equals V_{d} (i.e. V_{d} is proportional to displacement distance Δ₁), the transfer tank 16 is completely filled with liquid. For another, when the displacement device 52 is activated to expand the bladder 54, a volume of liquid is displaced in the transfer tank 16 that is equal to V_{d}. This causes the higher level liquid surface 42 to rise in the return tank 18 through a displacement distance Δ₂ to establish a pressure head, h₂.

For the configuration of the bi-level tank 14 shown in FIG. 2C, the exit port 38 is closed and the entry port 36 is opened after the module 20 passes through the exit port 38. Specifically, this configuration is established only after the module 20 has been ejected from the return tank 18. It is also to be noted in FIG. 2C, that the lower level liquid surface 40 in transfer tank 16 has receded back to where it was in FIG. 2A (i.e. Δ₁ is restored) because the displacement device 52 has been deactivated. Also, the higher level liquid surface 42 in return tank 18 has receded back to where it was in FIG. 2A because the module 20 has exited from the return tank 18. As intended for the present invention, after leaving the return tank 18, the module 20 will be returned to the launch pad 46 for its next duty cycle.

As envisioned for the present invention, the machine 10 is capable of working two types of electric generators 12. For one, the electric generator 12 can be an electromagnetic generator of a type well known in the pertinent art having a rotor 56 and a stator 58. For this type of electric generator 12, a gripper 60 is attached to the module 20 and a chain drive 62 is connected with the rotor 56 of the generator 12. The gripper 60 on the module 20 then engages with the chain drive 62 to move the chain drive 62 during the fall of the module 20 along the path 22. In turn, the chain drive 62 rotates the rotor 56 to generate electric power from the generator 12. In the other case, the electric generator 12 is a linear electric generator of a type well known in the pertinent art, and at least one magnet (not shown) is mounted on the module 20. A solenoid (also not shown) is positioned along the path 22 of the module 20 to generate electric power as the module 20 falls along the path 22 for an interaction between the moving magnet on the module 20 and the solenoid.

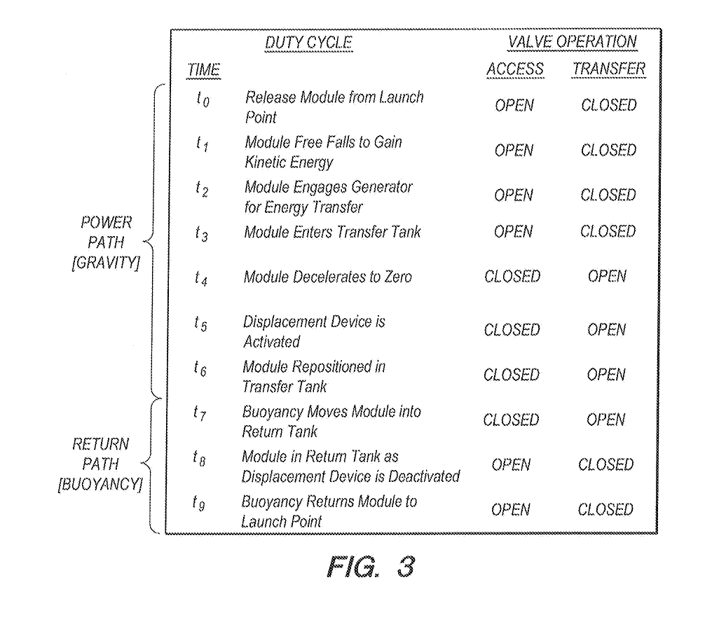

An operation of the present invention will be further appreciated with reference to FIG. 3, and with an appreciation of the fact that the control unit 30 coordinates several aspects of the machine 10 during a duty cycle. In detail, the control unit 30 coordinates the following:
Releases the module 20 at the time to from the launch point 26 to begin a duty cycle;
Changes configurations of access valve 32 and transfer valve 34 between time t₃ and t₄;
Activates the displacement device 52 at time t₅;
Moves pivot mechanism 50 to reposition submerged module 20 at time t₆;
Changes configurations of access valve 32 and transfer valve 34 between time t₇ and t₈; and
Deactivates the displacement device 52 at time t₈.

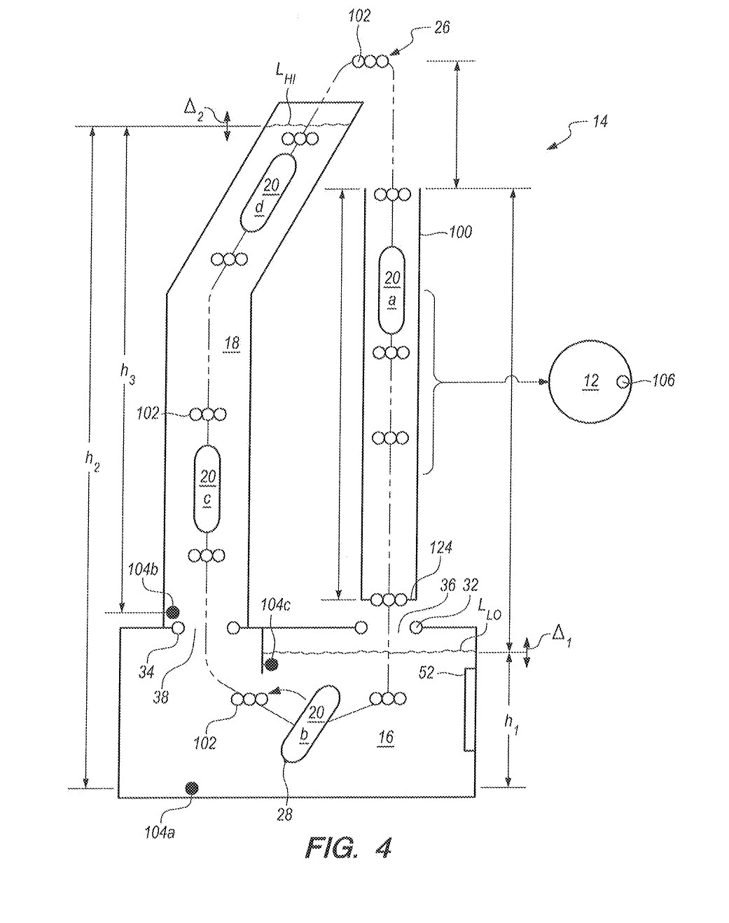

With reference to FIG. 4, it is to be understood that the chain drive 62 is represented as a linear generator 100. As mentioned earlier, either the chain drive 62 or a solenoid can be used as the linear generator 100 for the present invention. In either case, the functionality remains the same. Namely, a module 20 needs to be somehow engaged with the linear generator 100 as the module 20 falls under the influence of gravity. Thus, the linear generator 100 will necessarily include a linear engagement mechanism of a type well known in the pertinent art that is preferably oriented vertically.

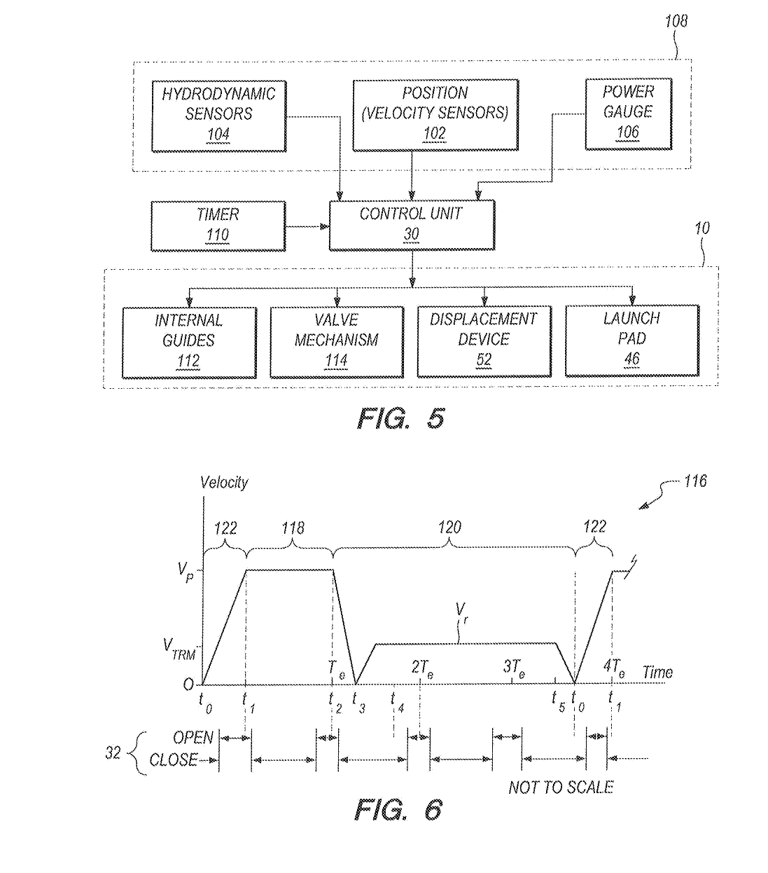

In accordance with above disclosure, an operation of the present invention requires precise velocity control over each module 20 during its duty cycle. Preferably, the present invention will involve a multi-module machine 10 that simultaneously uses four modules 20a-d. Still referring to FIG. 4, it will be appreciated that for purposes of the present invention, a plurality of position/velocity control sensors 102 are variously mounted on the machine 10. Additionally, a plurality of hydrodynamic sensors 104a-c are submerged in the bi-level tank 14. Further, FIG. 4 shows that an output power gauge 106 is mounted on the electric generator 12. Collectively, as indicated in FIG. 5, the positon/velocity sensors 102, the hydrodynamic sensors 104, and the output power gauge 106 constitute a sensor array 108.

Within the sensor array 108, the plurality of position/velocity sensors 102 are specifically located on the machine 10 to measure positions and velocities of each module 20 as it passes selected points during its respective duty cycle. To do this, at least one position/velocity sensor 102 is positioned at the launch point 26 to determine when a module 20 is ready for launch. At least one position/velocity sensor 102 is located on the power path 22 (e.g. module 20a) to monitor the velocity Vₚ of modules 20 while they are driving the electric generator 12 by their engagement with the linear generator 100. Also, a plurality of position/velocity sensors 102 are positioned in the bi-level tank 14. More specifically, position/velocity sensors 102 are positioned in the transfer tank 16 to monitor the transfer of a module 20 (e.g. module 20b) from the transfer tank 16 into the return tank 18. Further, position/velocity sensors 102 are positioned in the return tank 18 to ensure appropriate duty cycle locations for modules 20 (e.g. modules 20c and 20d) in preparation for a subsequent launch.

The plurality of hydrodynamic sensors 104 are submerged in the bi-level tank 14 to measure fluid characteristics of the liquid in the bi-level tank 14. In particular, at least one hydrodynamic sensor 104 (e.g. sensor 104a) records fluid pressure in the transfer tank 16 when the entry port 36 is open and the exit port 38 is closed. At least one other hydrodynamic sensor 104 (e.g. sensor 104b) records fluid pressure in the transfer tank 16 when the entry port 36 is closed and the exit port 38 is open. And, at least one hydrodynamic sensor 104 (e.g. sensor 104c) records fluid pressure in the transfer tank 16 to monitor variations Δ₁ in the lower level liquid surface Lₗₒ of the transfer tank 16. The general purpose here is to provide hydrodynamic values that can affect the velocity of a module 20 in the bi-level tank 14, and to provide information to the control unit 30 pertaining to Lₕᵢ and Lₗₒ and their respective variations Δ₂ and Δ₁ that is needed for timely operation of the valves at the entry port 36 and the exit port 38. Additionally, the hydrodynamic sensors 104 in the transfer tank 16 provide important information to the control unit 30 regarding fluid pressure values in the transfer tank 16 that must be accounted for during a proper operation of the displacement device 52.

Referring now to FIG. 5, it will be seen that the control unit 30 is connected in electronic communication with a timer 110 and with other components of the machine 10, as well as with the sensor array 108. Specifically, as noted above, the control unit 30 uses the timer 110 to coordinate the operation of the various system components. In particular, these components include the launch pad 46 and the displacement device 52. They also include internal guides 112 such as the pivot mechanism 50 and other mechanical features of the machine 10 that assist in keeping modules 20 on their appropriate travel paths during a duty cycle. Additionally, a valve mechanism 114 is provided that includes the access valve 32 for entry port 36 and the transfer valve 34 for exit port 38. Specifically, valve mechanism 114 is provided to allow access for modules 20 into the bi-level tank 14 and to maintain respective surface levels in the bi-level tank 14.

Operational control for the machine 10 will be best appreciated with reference to FIG. 6, where an exemplary duty cycle 116 for one module 20 is presented. In overview, FIG. 6, shows this duty cycle 116 in a context with the operation of an access valve 32. Recall, when access valve 32 is open, transfer valve 34 will be closed and vice versa.

With reference to the time line in FIG. 6, it is to be appreciated that a duty cycle 116 can be considered as either extending from tₒ to tₒ, or from t₁ to t₁. The difference here depends on whether a start for the duty cycle is considered to begin at the time of launch for a module 20 (tₒ) or at the time t₁ when the module 20 engages with the linear generator 100. In either case, the engagement time Tₑ will extend from t₁ to t₂. Thus, for a four-module machine 10, as shown in FIG. 6, a complete duty cycle 116 (e.g. from t₁ to t₁) will have a duration equal to 4Tₑ.

With the above in mind, recall that the times and velocities of a module 20 as it travels through a duty cycle 116 must necessarily be based on Tₑ. Also, there are two velocities in a duty cycle 116 that will remain substantially constant. First, the velocity Vₚthat a module 20 has during a power phase 118 of the duty cycle 116 while it is engaged with the linear generator 100 for the time Tₑ needs to be constant. Second, the velocity Vᵣ which is the terminal velocity attained by the module 20 while it is submerged in the bi-level tank 14 during a return phase 120 of the duty cycle 116 will remain substantially constant. Module velocities other than Vₚ and Vᵣ are transitional velocities which either decrease toward zero from Vₚ or Vᵣ or, depending on the position of the module 20 in the duty cycle 116, will increase from zero to Vₚ or Vᵣ.

FIG. 6 shows that from the time to when a module 20 is launched for free fall 122 from the launch pad 46, until it engages with the linear generator 100 at time t₁, the velocity of a module 20 increases from zero to Vₚ. For the present invention, Vₚ will depend on the weight of a module 20, and the distance of its travel while engaged with the linear generator 100. Importantly, Vₚ for a module 20 is determined so it will generate the voltage and sine wave characteristics that are required by the end user of the electric generator 12 (e.g. a grid). As mentioned above, Vₚ can be controlled by control unit 30 using output from power gauge 106 to determine appropriate loading provided by the linear generator 100.

As shown, Vₚ is held constant between t₁ and t₂. Note: at the time t₂, as a module 20 disengages from the linear generator 100, the successive module 20 will simultaneously engage with the linear generator 100. Also, it is important to note that at the time t₂, the entry port 36 will be open to allow the disengaged module 20b to enter the transfer tank 16. During this time, the exit port 38 will accordingly be closed. As a safety feature, in order to ensure that entry port 36 is indeed open, a mechanical trip switch 124 (see FIG. 4) can be provided at a predetermined distance above the entry port 36. Shortly after t₂, however, once the module 20 has entered the transfer tank 16, entry port 36 immediately closes.

Between the times t₂ and t₃, entry port 36 is closed and exit port 38 is opened. In this time interval, the displacement device 52 is activated (e.g. inflated) to force a volume of liquid from the transfer tank 16, through the now-open exit port 38. Specifically, as noted elsewhere herein, this displaced volume of liquid will be equal to the volume of the module 20 that is in the transfer tank 16 at the time.

While it is inside the transfer tank 16, the module 20b will decelerate to zero at the time t₃. Then, after being reoriented by the pivot mechanism 50, the module 20 will accelerate to its terminal velocity Vᵣ as it transitions from the transfer tank 16 and into the return tank 18. By time t₄, the module 20 will be completely inside the return tank 18. It is important that the time interval between t₂ and t₄ must necessarily be less than Tₑ. This is so because at a time t₂+Tₑ the next module 20 will need to enter the transfer tank 16 during its duty cycle 116.

Still referring to FIG. 6 it will be appreciated that a module 20 will essentially maintain its terminal velocity Vᵣ in the return tank 18 until it is ejected from the return tank 18 at a time t₅. Between t₅ when a module 20 is ejected from the return tank 18 and the time tₒ for starting its next duty cycle 116, the module 20 will decelerate from Vᵣ to zero. Deceleration is complete when the module 20 is on the launch pad 46 to begin its next duty cycle 116 with a free fall 122.

It is to be appreciated that the above disclosure with reference to FIG. 6 has been described in terms of a duty cycle 116 for only one module 20. As previously noted, however, the present invention envisions using four modules 20a-d. Accordingly, all four modules 20a-d will experience a same duty cycle 116, and the duration of each duty cycle 116 will be 4Tₑ. This is so in order for each module 20 to have a same Tₑ for its engagement with the generator 100. As intended for the present invention, all of this is controlled by the control unit 30.

While the particular Control System for Machine Electric Generator as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for controlling a machine to drive a power generator which comprises:
a power generator;
a module, wherein the module is engaged with the power generator to generate power during a first portion of a predetermined duty cycle for the module;
a bi-level tank for holding a liquid, wherein the bi-level tank includes a transfer tank connected in fluid communication with a return tank, wherein the transfer tank has a lower level liquid surface, Lₗₒ, with a covered entry port into the transfer tank, and the return tank has an open upper level liquid surface, Lₕᵢ, with a submerged exit port located between the transfer tank and the return tank, wherein the bi-level tank receives the module for transit therethrough during a second portion of the predetermined duty cycle;
a sensor array connected to the bi-level tank and to the power generator;
a valve mechanism for opening the entry port to receive a module only when the exit port is closed and for opening the exit port to recycle the module only when the entry port is closed; and
a control unit connected to the sensor array, to the valve mechanism, and to the power generator for maintaining the Lₕᵢ and Lₗₒ liquid surface levels at respectively different levels by coordinating an operation of the valve mechanism with predetermined velocities of the module during the duty cycle.

2. The system of claim 1 further comprising:
a launch pad for dropping the module at a predetermined time in the duty cycle; and
a linear generator, wherein the linear generator is aligned along a power path between a launch point on the launch pad and the entry port of the transfer tank to generate electric power by its engagement with the module as the module falls by gravity from the launch point through a distance H_{drop} for engagement with the linear generator and thereafter for entry into the transfer tank for return by buoyancy of the module to the launch pad via the return tank, wherein the time the module is dropped from the launch pad is coordinated within a duty cycle by the control unit.

3. The system of claim 2 wherein the sensor array comprises:
a plurality of position/velocity sensors located on the machine to measure positions and velocities of a module at selected points in the duty cycle;
a plurality of hydrodynamic sensors submerged in the bi-level tank to measure fluid characteristics of the liquid in the bi-level tank; and
a power output gauge mounted on the power generator to determine characteristics of an electrical power output.

4. The system of claim 3 wherein at least one position/velocity sensor is positioned at the launch point, at least one position/velocity sensor is located on the power path, and a plurality of position/velocity sensors are positioned in the bi-level tank.

5. The system of claim 3 wherein at least one hydrodynamic sensor records fluid pressure in the transfer tank when the entry port is open and the exit port is closed, at least one hydrodynamic sensor records fluid pressure in the transfer tank when the entry port is closed and the exit port is open, and at least one hydrodynamic sensor records fluid pressure in the transfer tank to monitor variations in the lower level liquid surface Lₗₒ.

6. The system of claim 3 wherein a velocity Vₚ is maintained constant for a module during its engagement with the power generator to comply with operational requirements of the power generator.

7. The system of claim 6 wherein Vₚ is established by the control unit by varying the load on the power generator.

8. The system of claim 3 further comprising a displacement device submerged in the transfer tank, wherein the displacement device has a variable volume controlled by the control unit, and wherein the volume of the displacement device is reconfigured to a first configuration with an increased volume when the entry port is closed and is reconfigured to a second configuration with a decreased volume when the entry port is open.

9. The system of claim 3 wherein the linear generator is selected from the group consisting of a chain drive and a solenoid.

10. The system of claim 3 further comprising a gantry extending above the bi-level tank for holding the launch point at a drop height, H_{drop}, above Lₗₒ, wherein H_{drop} is greater than the distance between Lₕᵢ and Lₗₒ (H_{drop}>Lₕᵢ−Lₗₒ).

11. A system for controlling a machine to drive a power generator which comprises:
a power generator;
a module, wherein the module is engaged with the power generator to generate power during a first portion of a predetermined duty cycle for the module;
a bi-level tank for holding a liquid, wherein the bi-level tank includes a transfer tank connected in fluid communication with a return tank, wherein the transfer tank has a lower level liquid surface, Lₗₒ , with a covered entry port into the transfer tank, and the return tank has an open upper level liquid surface, Lₕᵢ, with a submerged exit port located between the transfer tank and the return tank, wherein the bi-level tank receives the module for transit therethrough during a second portion of the predetermined duty cycle;
a valve mechanism for opening the entry port to receive a module only when the exit port is closed and for opening the exit port to recycle the module only when the entry port is closed;
a launch pad for dropping the module at a predetermined time in the duty cycle;
a second generator, wherein the second generator is aligned along a power path between a launch point on the launch pad, and the entry port of the transfer tank to generate electric power by its engagement with the module as the module falls by gravity from the launch point through a distance H_{drop} for engagement with the second generator and thereafter for entry into the transfer tank for return by buoyancy of the module to the launch pad via the return tank, wherein the time the module is dropped from the launch pad is coordinated within a duty cycle by the control unit;
a plurality of position/velocity sensors, wherein at least one position/velocity sensor is positioned at the launch point, at least one position/velocity sensor is located on the power path, and a plurality of position/velocity sensors are positioned in the bi-level tank; and
a control unit connected to the plurality of position/velocity sensors or controlling predetermined velocities of the module during the duty cycle.

12. The system of claim 11 further comprising a plurality of hydrodynamic sensors submerged in the bi-level tank to measure fluid characteristics of the liquid in the bi-level tank, wherein at least one hydrodynamic sensor records fluid pressure in the transfer tank when the entry port is open and the exit port is closed, at least one hydrodynamic sensor records fluid pressure in the transfer tank when the entry port is closed and the exit port is open, and at least one hydrodynamic sensor records fluid pressure in the transfer tank to monitor variations in the lower level liquid surface Lₗₒ.

13. The system of claim 12 further comprising a power output gauge mounted on the power generator to determine characteristics of an electrical power output.

14. The system of claim 13 wherein a velocity Vₚ is maintained constant for a module during its engagement with the power generator to comply with operational requirements of the power generator, and wherein Vₚ is established by the control unit by varying the load on the power generator.

15. The system of claim 14 further comprising a displacement device submerged in the transfer tank, wherein the displacement device has a variable volume controlled by the control unit, and wherein the volume of the displacement device is reconfigured to a first configuration with an increased volume when the entry port is closed and is reconfigured to a second configuration with a decreased volume when the entry port is open.

16. A system for controlling a machine to drive a power generator which comprises:
a power generator;
a module, wherein the module is engaged with the power generator to generate power during a first portion of a predetermined duty cycle for the module;
a bi-level tank for holding a liquid, wherein the bi-level tank includes a transfer tank connected in fluid communication with a return tank, wherein the transfer tank has a lower level liquid surface, Lₗₒ, with a covered entry port into the transfer tank, and the return tank has an open upper level liquid surface, Lₕᵢ, with a submerged exit port located between the transfer tank and the return tank, wherein the bi-level tank receives the module for transit therethrough during a second portion of the predetermined duty cycle;
a valve mechanism for opening the entry port to receive a module only when the exit port is closed, and for opening the exit port to recycle the module only when the entry port is closed;
a launch pad for dropping the module at a predetermined time in the duty cycle;
a second generator, wherein the second generator is aligned along a power path between a launch point on the launch pad and the entry port of the transfer tank to generate electric power by its engagement with the module as the module falls by gravity from the launch point through a distance H_{drop} for engagement with the second generator and thereafter for entry into the transfer tank for return by buoyancy of the module to the launch pad via the return tank, wherein the time the module is dropped from the launch pad is coordinated by the control unit;
a plurality of hydrodynamic sensors, wherein at least one hydrodynamic sensor records fluid pressure in the transfer tank when the entry port is open and the exit port is closed, at least one hydrodynamic sensor records fluid pressure in the transfer tank when the entry port is closed and the exit port is open, and at least one hydrodynamic sensor records fluid pressure in the transfer tank to monitor variations in the lower level liquid surface Lₗₒ; and
a control unit connected to the plurality of hydrodynamic sensors for maintaining the Lₕᵢ and Lₗₒ liquid surface levels at respectively different levels during an operation of the system.

17. The system of claim 16 further comprising a power output gauge mounted on the power generator to determine characteristics of an electrical power output.

18. The system of claim 17 wherein a velocity Vₚ is maintained constant for a module during its engagement with the power generator to comply with operational requirements of the power generator, and wherein Vₚ is established by the control unit by varying the load on the power generator.

19. The system of claim 18 further comprising a displacement device submerged in the transfer tank, wherein the displacement device has a variable volume, and wherein the volume of the displacement device is reconfigured to a first configuration with an increased volume when the entry port is closed and is reconfigured to a second configuration with a decreased volume when the entry port is open.

20. The system of claim 19 further comprising a gantry extending above the bi-level tank for holding the launch point at a drop height, H_{drop}, above Lₗₒ, wherein H_{drop} is greater than the distance between Lₕᵢ and Lₗₒ (H_{drop}>Lₕᵢ−Lₗₒ).
